(19) United States
(12) Patent Application Publication
(10) Pub. No.: US 2010/0287736 A1
(43) Pub. Date: Nov. 18, 2010

(54) GRIPPING DEVICE FOR HANDLES

(76) Inventor: Anthony L. Ameduri, Holmdel, NJ (US)

Correspondence Address: SANCHELIMA & ASSOCIATES, P.A.;JESUS SANCHELIMA, ESQ., 235 S.W. LE JEUNE ROAD, MIAMI, FL, 33134, US

(21) Appl. No.: 12/464,254

(22) Filed: May 12, 2009

(51) Int. Cl. B25G 1/10

(52) U.S. Cl. 16/430

(57) ABSTRACT

A gripping device for a handle's distal end that permits a user to insert his/her fingers through one or more adjustable loops that are connected to the tubular assembly embracing the handle. The tubular assembly has between one and four pairs of slots that permit a strap assembly to pass though. One of the ends of the strap assembly is rigidly mounted adjacent to the inner end of the tubular assembly. The distal end of the strap assembly extends outwardly through the outermost slot. Alternatively, the distal end of the strap assembly can extend inwardly towards the body of the racket, adjacent to the inner end of the tubular assembly while the other end of the strap assembly is rigidly mounted outwardly and adjacent to the outermost slot. A locking mechanism keeps the strap assembly in place relative to the slots through which it passes thereby keeping the adjusted dimensions of the finger loops fixed.

### BACKGROUND OF THE INVENTION

1. Field of the Invention

The present invention relates to a gripping device for handles, and more particularly, for racquet handles.

2. Description of the Related Art

Several designs for gripping devices for handles have been designed in the past. Their objective is to permit a user to achieve a comfortable grip of a handle typically of cylindrical shape. None of them, however, includes adjustable straps that define loops for a user's fingers. This is particularly desirable in sports applications such as tennis, racquetball, and any other sport where a firm grip of a handle is desirable.

Applicant believes that the closest reference corresponds to U.S. Pat. No. 4,226,418 issued to Balfour on Oct. 7, 1980 for a game racket hand grip. It includes a narrow web portion with four finger holes. However, it differs from the present invention because the holes for the finger are not adjustable to the user's fingers thereby leaving them loose within the holes. Additionally, users with thick fingers may require specially made hand grips while others will find it too big. Lastly, the rigidity of the device shown will make it uncomfortable.

Other patents describing the closest subject matter provide for a number of more or less complicated features that fail to solve the problem in an efficient and economical way. None of these patents suggest the novel features of the present invention.

### BRIEF DESCRIPTION OF THE DRAWINGS

With the above and other related objects in view, the invention consists in the details of construction and combination of parts as will be more fully understood from the following description, when read in conjunction with the accompanying drawings in which:

FIG. 1 represents an isometric view of one of the embodiments for the present invention.

FIG. 1A shows a partial cross-sectional view of the gripping device shown in the previous figure, taken from cutting along line 1A.

FIG. 2 illustrates an isometric view of the device shown in the previous figures mounted to the distal end of a racket handle.

FIG. 3 shows an isometric view of an alternate embodiment of the device shown in the previous figure.

FIG. 4 shows an enlarged partial cross-sectional view of locking mechanism 80.

### DETAILED DESCRIPTION OF THE INVENTION

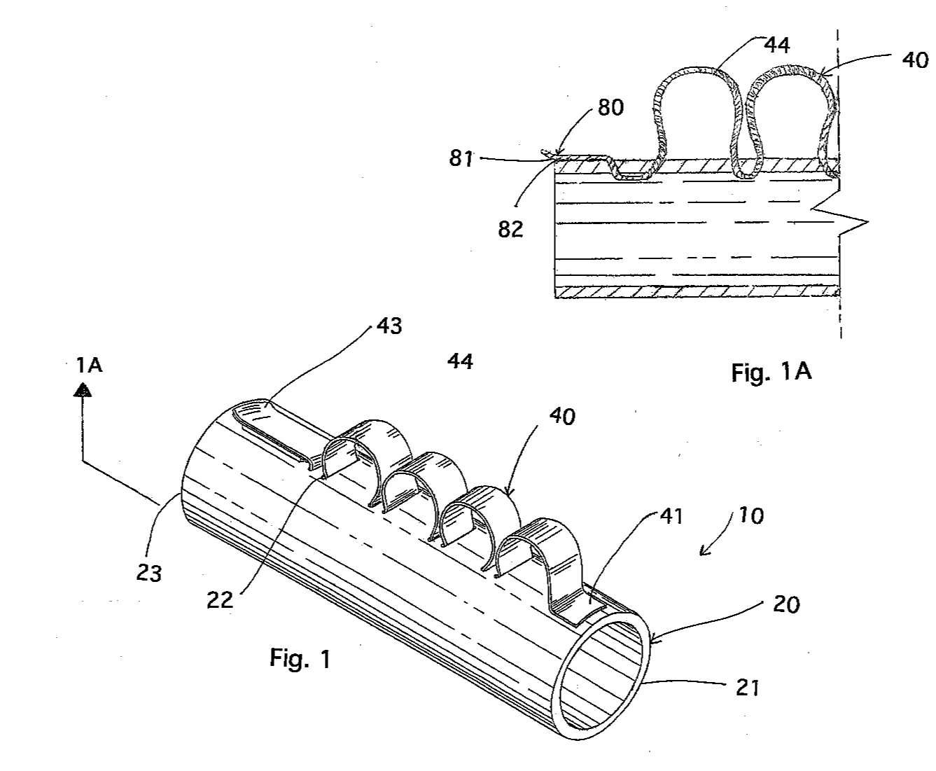

Referring now to the drawings, where the present invention is generally referred to with numeral 10, it can be observed that it basically includes tubular assembly 20 removably insertable to the distal end of a handle H and strap assembly 40 passed through a number of spaced apart through slots 22 defining finger loops 44. This is best seen in FIGS. 1 and 1A.

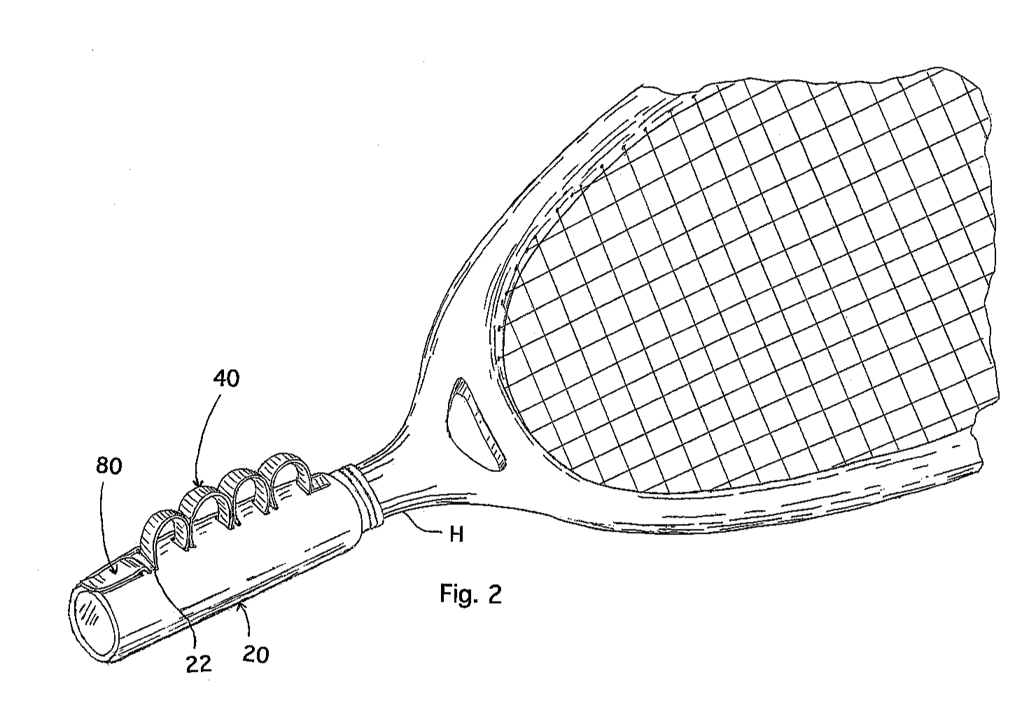

Tubular assembly 20 has cooperative dimensions to snuggly receive the distal end of handle H, as seen in FIG. 2. Assembly 20 can be made out of leather, or equivalent flexible material. Leather provides an effective grip with handle H similar to when a user wears a glove. In the embodiment shown in the drawings, eight slots 22 are shown. Slots 22 extend transversally a predetermined distance (slightly longer than the width of strap assembly 40) along tubular assembly 20 and are positioned at a cooperative spaced apart relationship to permit strap assembly 40 to define four finger loops 44, as shown in the drawings for this embodiment. A user may skip one, two, or three pairs of slots 22 thereby defining three, two, or one finger loops 44, respectively. Rubber can also be used for tubular assembly 20 and strap assembly 40 to lower production costs.

Strap assembly 40 is made out of a flexible material, such as leather, and has cooperative dimensions to be passed through slots 22. Strap assembly 40 includes ends 41 and 43. End 41 is mounted to a point adjacent to inner end 21 of tubular assembly 20. In the embodiment shown in the figures, end 41 is stitched to assembly 20. Distal end 43 of strap assembly 40 extends outwardly through the outmost slot 22.

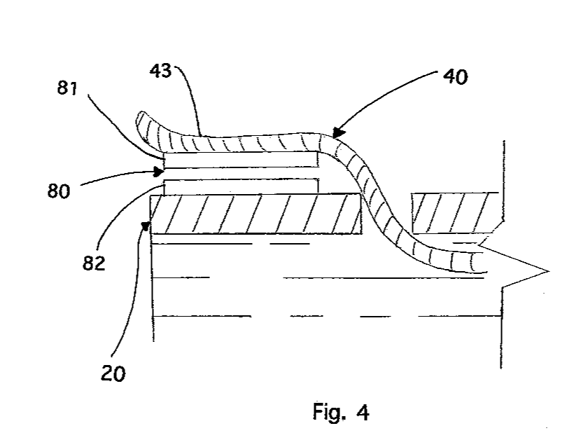

To adjust the internal diameter of finger loops 44, a user pulls end 43. Once a comfortable adjustment of strap assembly 40 is obtained, a user locks strap assembly 40 in place relative to slots 22 in order to maintain the desired tightness of finger loops 44 to a user's fingers. One of the locking mechanisms 80 used to accomplish this involves the use of pressure-sensitive adhesive elements such as mating hook 81 and loop 82 fasteners (Velcro) pads, as shown in FIG. 4. Other equivalent mechanisms, such as snap-buttons, buckles, etc. can also be used. Locking mechanism 80 acts out on the portion of the strap assembly that is adjacent to end 43, just outside of the outmost slot 22, and the portion of the tubular assembly that is between outmost slot 22 and end 23.

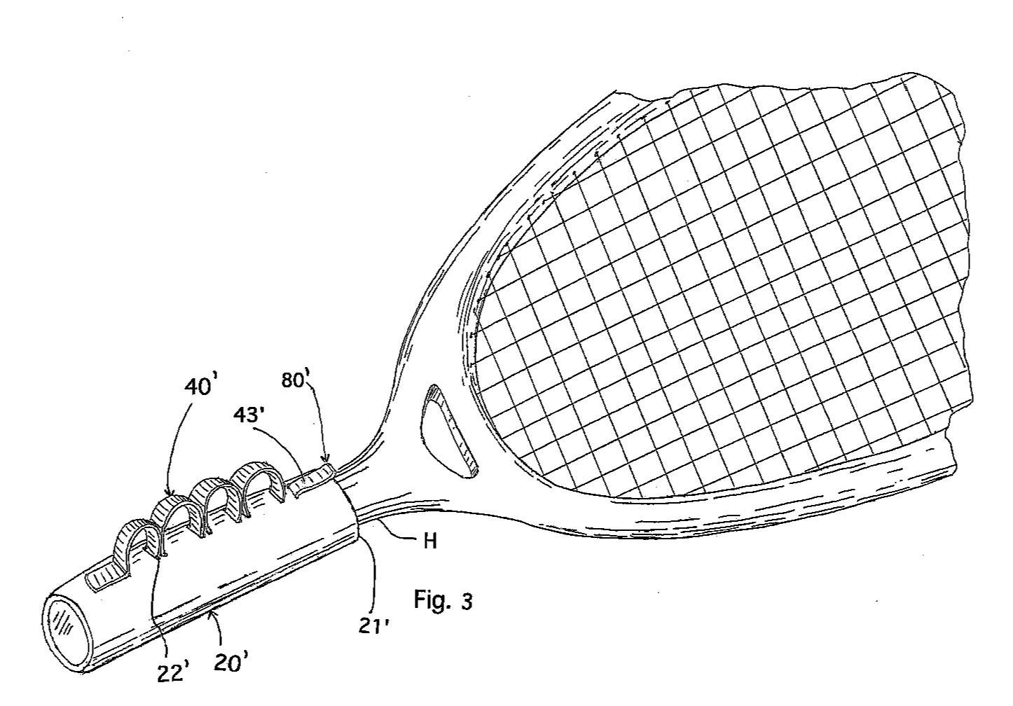

An alternate embodiment shown in FIG. 3 when locking mechanism 80′ is mounted adjacent to inner end 21′ of tubular assembly 20′. Distal end 43′ of strap assembly 40′ is next to the inner end 21′ and thus minimizes any interference with a user. Strap assembly 20′ operates the same way as strap assembly 20 and is passed through slots 22′. Lock mechanism 80 (and 80′) is shown in FIG. 4. The cross-sectional view shows how hook and loop members (Velcro or equivalent) 81 and 82 cooperate to keep strap assembly 40, and distal end 43, at a selected position.

A user's grip applies pressure on assembly 20 that in turn is transmitted against the handle. Finger loops 44 prevent any sliding movement of a user's hand along handle H.

The foregoing description conveys the best understanding of the objectives and advantages of the present invention. Different embodiments may be made of the inventive concept of this invention. It is to be understood that all matter disclosed herein is to be interpreted merely as illustrative, and not in a limiting sense.

What is claimed is:

1. A gripping device for handles, comprising:
A) an elongated tubular assembly having a substantially cylindrical cross-section, said tubular assembly including first and second ends, said first and second ends being open, and said tubular assembly having cooperative dimensions to receive a handle, and further including at least one pair of transversal slots kept at a parallel and spaced apart relationship with respect to each other;
B) an elongated flexible strap assembly having third and fourth ends with cooperative dimensions to permit its passage through said slots, said third end being rigidly mounted to said tubular assembly at an area adjacent to said first end, said strap assembly is passed through said at least one pair of transversal slots so that at least one loop is defined that extends outside of said tubular assembly for receiving at least on finger of a user therethrough; and
C) locking means for keeping said strap assembly at a predetermined adjustable position relative to said slots thereby keeping the dimensions of said at least one loop fixed so that said at least one loop comfortably conforms to a user's at least one finger to enhance the grip of said handle.

2. The device set forth in claim 1 wherein said locking means includes mating pressure-sensitive adhesive elements cooperatively mounted to said underside adjacent to said fourth end and on said outer surface adjacent to said second end.

3. The device set forth in claim 2 wherein said mating pressure-sensitive adhesive elements include hook and loop fasteners.

4. The device set forth in claim 3 wherein said tubular assembly includes four pairs of slots through which said strap assembly passes defining four loops.

5. The device set forth in claim 4 wherein said tubular assembly is made out of leather.

6. The device set forth in claim 5 wherein said second end is open.

7. The device set forth in claim 6 wherein said tubular assembly snuggly fits over said handle.

8. The device set forth in claim 3 wherein said tubular assembly includes three pairs of slots through which said strap assembly passes defining three loops.

9. The device set forth in claim 3 wherein said tubular assembly includes two pairs of slots through which said strap assembly passes thereby defining two loops.
